(19) United States
(12) Patent Application Publication
(10) Pub. No.: US 2024/0286100 A1
(43) Pub. Date: Aug. 29, 2024

(54) Apparatus and Method for the Production of Hydrogen

(71) Applicant: XGas AS, Fana (NO)

(72) Inventors: Matthias Brunner, Fana (NO); Arne Godal, Fana (NO)

(21) Appl. No.: 18/573,001

(22) PCT Filed: Jun. 22, 2022
(86) PCT No.: PCT/EP2022/067034

§ 371 Date: Dec. 21, 2023

(30) Foreign Application Priority Data
Jun. 22, 2021 (GB) 2108950.3

(51) Int. Cl. B01J 6/00; C01B 3/24; C09C 1/50

(52) U.S. Cl. CPC B01J 6/008; C01B 3/24; C09C 1/50; C01B 2203/0272; C01B 2203/085; C01B 2203/1241

(57) ABSTRACT

An apparatus (100) for the pyrolytic decomposition of a hydrocarbon fuel into a plurality of products including a reaction chamber (102) and an electrically conducting coil (104) surrounding the reaction chamber (102). The reaction chamber (102) has an inlet, for supplying hydrocarbon fuel into the reaction chamber (102) and an outlet for the products of the pyrolytic decomposition, and the electrically conducting coil (104) surrounds the reaction chamber (102) between the inlet and the outlet. The electrically conducting coil (102) receives an alternating current and heats the reaction chamber (102) by induction.

### FIELD OF THE DISCLOSURE

This invention relates to an apparatus and method for the pyrolytic decomposition of a hydrocarbon fuel, of which hydrogen is a product.

### BACKGROUND

Hydrogen is an attractive fuel source as it is lightweight, provides a high energy return for its mass (120,000 KJ/kg) and produces a harmless combustion product (water vapor). However, hydrogen does not occur in significant amounts in the atmosphere and therefore needs to be produced.

In the present invention, hydrogen is produced by the thermal or pyrolytic decomposition of hydrocarbons, which can be represented by the following reaction:

$$C {H}_{4} \to C + {H}_{2}$$

This process is attractive because it provides as the products hydrogen (a non-toxic fuel) and carbon black (a carbonaceous product). Carbon black has numerous uses in industry, e.g. a pigment and reinforcing agent in automobile tires, an additive in coatings and plastics and a pigment in inks.

WO 2018/015564 describes a process for hydrogen production via the thermal decomposition of a hydrocarbon fuel using an electrical heating source that heats a reaction chamber via conduction of the heat from the heating source to the thermally conducting reaction chamber wall which then in turn radiates heat to the hydrocarbon gas flowing through the reaction chamber.

### SUMMARY

It is an aim of the present invention to provide an improved method and apparatus for the pyrolytic decomposition of a hydrocarbon fuel with an improved thermal efficiency and conversion efficiency.

When viewed from a first aspect, the invention provides an apparatus for the pyrolytic decomposition of a hydrocarbon fuel into a plurality of products, the apparatus comprising:
a reaction chamber comprising:
   an inlet for supplying hydrocarbon fuel into the reaction chamber; and
   an outlet for the products of the pyrolytic decomposition; and
an electrically conducting coil surrounding the reaction chamber between the inlet and the outlet of the reaction chamber;
wherein the electrically conducting coil is arranged to receive an alternating current and heat the reaction chamber by induction.

The present invention thus provides an apparatus for the pyrolytic decomposition of a hydrocarbon fuel by electrically heating via induction at least part of the reaction chamber. Induction heating works by passing an alternating electric current through an electrically conducting material (e.g. the electrically conducting coil of the present invention) which in turn generates an alternating magnetic field. When an electrically conductive material is placed in the alternating magnetic field, eddy currents are induced within the electrically conductive material which results in localized heating of (i.e. the surface or wall of) the electrically conducting material via the skin effect. The heat generated in the electrically conductive material may then be conducted through thermally conducting material and/or radiate from the material into the surrounding environment. For example, the heat generated in the electrically conductive material may be transferred to the hydrocarbon fuel flowing therethrough to allow heat to be transferred along the radiation chamber and by thermal convection.

In the present invention, the electrically conducting coil is positioned between the reaction chamber inlet and the reaction chamber outlet and is arranged to surround the reaction chamber such that, when an alternating electric current is passed through the electrically conducting coil, the reaction chamber is heated via induction. The heat generated by the generated alternating magnetic field penetrating the reaction chamber may be conducted through the reaction chamber such that at least part of the heat generated in the reaction chamber wall may be radiated towards the hydrocarbon fuel flowing therethrough (i.e. from the inlet to the outlet) to temperatures at which pyrolytic decomposition may occur.

Thus, in a further aspect of the present invention, a method for the pyrolytic decomposition of a hydrocarbon fuel into a plurality of products is provided, the method comprising:
introducing a hydrocarbon fuel into a reaction chamber;
passing an alternating current through an electrically conductive coil surrounding the reaction chamber such that an alternating magnetic field is generated to inductively heat the reaction chamber; and
heating the hydrocarbon fuel in reaction chamber to effect pyrolytic decomposition of the hydrocarbon fuel.

Preferably, the method further comprises the use of the apparatus as described herein. As will be appreciated by those skilled in the art, the apparatus used in the method of the present invention can and preferably does include any one or more or all of the preferred and optional features of the apparatus described herein, as appropriate.

The present invention therefore provides a method (e.g. using the apparatus as described herein) and apparatus (e.g. for use in the method as described herein) of the pyrolytic decomposition of hydrocarbon fuels using a non-polluting heat source that does not require direct contact between the heating source and the reaction chamber.

As will be discussed herein, the present invention provides a method and apparatus that may allow heating of the reaction chamber (which in turn heats the hydrocarbon fuel in reaction chamber) to greater temperatures than conventional methods of plasma pyrolytic decomposition using conductive heating such that an improved thermal efficiency may be achieved. Thus, the present invention helps to provide improved conversion yield and conversion efficiency of a hydrocarbon fuel to a plurality of products including a carbonaceous product and hydrogen. The present invention may also help to provide an improved quality and size distribution of the carbonaceous product, as well as improved thermal efficiency.

Achieving higher temperatures may reduce the reaction time (by increasing the reaction rate), which in turn may increase throughput as well as the kinematic viscosity of the gas providing an improved laminar flow. The laminar flow helps to allow the hydrocarbon fuel to flow in a non-turbulent manner and thus allows the heat transferred to the hydrocarbon fuel to be effectively and evenly distributed such that effectively all of the hydrocarbon fuel entering the apparatus is decomposed to the desired reaction products.

The apparatus (e.g. for use in the method described herein) preferably comprises a hydrocarbon fuel supply which is in fluid communication with, and upstream of, the reaction chamber inlet and arranged to supply a flow of hydrocarbon fuel to the reaction chamber.

The reaction chamber preferably comprises a cavity (e.g. extending through the reaction chamber) and at least one wall (e.g. defining the cavity), wherein the hydrocarbon fuel is arranged to flow (is input) from the inlet into the cavity of the reaction chamber (towards the outlet of the cavity). Preferably the at least one wall extends from the inlet to the outlet to enclose the cavity (apart from the apertures of the inlet and outlet).

In these embodiments, preferably the electrically conducting coil surrounds the wall(s) of the reaction chamber such that the alternating magnetic field generated by the electrically conducting coil penetrates and thus heats the wall(s) of the reaction chamber. It will be appreciated that the heat generated in the walls (e.g. at the surface of the walls) is conducted through the reaction chamber wall towards the cavity (e.g. the cavity through which the hydrocarbon fuel is flowed) such that at least part of the heat generated in the reaction chamber wall is radiated into the cavity to heat the hydrocarbon fuel flowing therethrough (i.e. from the inlet to the outlet) to the temperatures at which pyrolytic decomposition occurs. The heat generated in the walls may be transferred to the hydrocarbon fuel flowing therethrough to allow heat to be transferred along the radiation chamber and by thermal convection

The reaction chamber may comprise any suitable and desired number of walls, e.g. to form any suitable and desired cross-sectional shape. The reaction chamber may comprise n number of walls defining any circular, ovular or n-sided polygon cross-sectional shape. For example, the reaction chamber may comprise one wall (n=1) defining a cross-sectional shape of a circle or oval. In some embodiments n=3 (e.g. a triangle), e.g. n=4 (e.g. a square, a rectangle, a diamond or a rhombus), e.g. n=5 (e.g. a regular or irregular pentagon), e.g. n=6 (e.g. a regular or irregular hexagon), e.g. n>6 (e.g. a regular or irregular heptagon, octagon, nonagon, decagon, etc.).

The reaction chamber inlet and outlet may define a longitudinal axis, e.g. extending between the (e.g. center of the) inlet and the (e.g. center of the) outlet. In some embodiments, the reaction chamber extends along or in parallel with the longitudinal axis. The reaction chamber may be considered to extend along the longitudinal axis when the longitudinal axis intersects the center of the reaction chamber's cross-section (e.g. in the plane perpendicular to the longitudinal axis). Similarly, the reaction chamber may be considered to extend in parallel to the longitudinal axis when the longitudinal axis does not intersect the center of the reaction chamber's cross-section (e.g. in the plane perpendicular to the longitudinal axis) such that the reaction chamber is offset from, but extends in parallel with, the longitudinal axis.

In preferred embodiments the reaction chamber has a prismatic shape (i.e. the three-dimensional shape is a prism), with any suitable and desired polygon cross-sectional shape perpendicular to the longitudinal axis. In preferred embodiments the reaction chamber comprises a cylindrical conduit (e.g. tube, e.g. pipe), e.g. that extends from the inlet to the outlet, e.g. along or in parallel with the longitudinal axis.

In preferred embodiments the wall(s) of the reaction chamber extend linearly along or parallel with the longitudinal axis, e.g. the conduit is straight. However, in some embodiments the reaction chamber may extend non-linearly along or in parallel with the longitudinal axis, e.g. the conduit itself may be shaped as a spiral or coil wound around the longitudinal axis and extending from the inlet to the outlet. A non-linear design may, for example, be used to increase the effective length (and thus reaction chamber volume) over which the hydrocarbon fuel is heated without extending the length of the coil (and thus energy requirements) used to heat the reaction chamber.

In preferred embodiments, the (e.g. cavity of the) reaction chamber is empty (e.g. prior to introducing the hydrocarbon fuel therein via the inlet) and has no (e.g. removable) solid particulate material located therein. Thus, when in use, the (e.g. cavity of the) reaction chamber preferably only contains the hydrocarbon fuel and the products of the pyrolytic decomposition flowing therethrough. For example, the reaction chamber does not contain any catalytic material, and preferably the method of pyrolytic decomposition as defined herein is uncatalyzed (i.e. it is not mediated by the presence of catalytic material).

In some systems known in the art, catalytic material may be provided to reduce the temperature required to activate reactions (i.e. lowering the activation energy to the products along the reaction pathway) such as decomposition, and achieve higher conversion yields. This may be seen as desirable when the temperatures required for certain processes are very high and thus difficult to obtain and/or unpredictable. However, at least preferred embodiments of the present invention aim to provide an apparatus and method of decomposition of hydrocarbon fuels that can achieve both high temperatures with an even and/or predictable temperature gradient across the reaction chamber using induction heating. This may render the need for catalytic materials obsolete.

The apparatus (e.g. for use in the method described herein) of the present invention comprises a (e.g. at least one) reaction chamber and the method (e.g. using the apparatus described herein) comprises introducing a hydrocarbon fuel into a (e.g. at least one) reaction chamber. In some embodiments, the apparatus may comprise (and the method may introduce a hydrocarbon fuel into) more than one reaction chamber, e.g. two, three, four, five, six or seven reaction chambers, e.g. a plurality of reaction chambers. In embodiments comprising more than one (e.g. a plurality) of reaction chambers, the reaction chambers may be arranged in parallel with respect to each other, e.g. all of the reaction chambers extend along or in parallel with the longitudinal axis.

In preferred embodiments, the plurality of reaction chambers are arranged in parallel with each other (and, e.g., the longitudinal axis) in any suitable and desired configuration. For example, three reaction chambers may be arranged to form a triangle (e.g. the cross-section of each reaction chamber is centered on and, e.g. each reaction chamber extends along, the corner of the triangle), four reaction chambers may be arranged to form a square, rhombus or diamond (e.g. the cross-section of each reaction chamber is centered on and, e.g. each reaction chamber extends along, an apex or corner), five reaction chambers may be arranged to form a pentagon (e.g. the cross-section of each reaction chamber centered on and, e.g. each reaction chamber extends along, an apex or corner) or a square arrangement with one reaction chamber in the center (e.g. the cross-section of four reaction chambers centered on and, e.g. each reaction chamber extends along, the corner of the square and one positioned in the center), six reaction chambers may be arranged to form a hexagon (e.g. the cross-section of each reaction chamber centered on and, e.g. each reaction chamber extends along, an apex or corner) or a pentagon with a reaction chamber in the center (e.g. the cross-section of each five reaction chambers centered on and, e.g. each reaction chamber extends along, an apex or corner and the e.g. cross-section of one reaction chamber is centered on and, e.g. extends along, the center of the pentagon), and so on.

An (e.g. at least one) electrically conducting coil is arranged to surround a (e.g. at least one) reaction chamber. In some embodiments, the apparatus (e.g. for use in the method described herein) comprises the same number of electrically conducting coils as the number of reaction chambers. For example, in some embodiments the apparatus comprises two or more (e.g. three, e.g. four, e.g. five, e.g. six, e.g. seven or more) reaction chambers with each reaction chamber being surrounded by a respective electrically conducting coil. In these embodiments, the reaction chambers are preferably arranged in parallel (e.g. in any suitable and desired shape or configuration, as described above) but are preferably not in direct contact with each other. This helps to provide sufficient space between the reaction chambers for the electrically conducting coils to surround the respective reaction chambers.

In some embodiments, one electrically conducting coil may surround more than one (a plurality of) reaction chambers. For example, one electrically conducting coil may be arranged to surround more than one (a plurality of) reaction chamber(s). In these embodiments, a plurality of reaction chambers may be arranged within a single electrically conducting coil such that the magnetic field generated by the single coil acts to heat at least the part of the reaction chambers around which the coil surrounds simultaneously.

In these embodiments, the reaction chambers are preferably arranged in parallel (e.g. in any suitable and desired shape or configuration, as described above) and may or may not be in direct contact with each other. For example, all of the reaction chambers may be in direct contact, such that the plurality of reaction chambers may transfer heat between each other via conduction. In some embodiments, the plurality of reaction chambers may not be in direct contact, e.g. as such a configuration may provide a more even distribution across the alternating magnetic field (and thus a more isotropic heating).

Providing a plurality of reaction chambers helps to allow a greater volume of hydrocarbon gas to be heated at the same time, with only minimal reduction of the quality (e.g. isotropy) of the cross-sectional thermal profile (e.g. in the axis perpendicular to the longitudinal axis of the reaction chamber). As such, the thermal efficiency of the decomposition process may be improved and the rate of hydrogen output increased.

In some embodiments, the apparatus (e.g. for use in the method described herein) comprises a greater number of electrically conducting coils than the number of reaction chambers. For example, the apparatus may comprise one reaction chamber and two or more electrically conducting coils. In such embodiments the electrically conducting coils are preferably arranged to be adjacent to (e.g. in series with) each other such that each electrically conducting coil inductively heats (e.g. continuously) adjacent regions of the reaction chamber to provide continuous heating along a length of the reaction chamber that is greater than the length of a single (or pair of) electrically conducting coils.

The reaction chamber may comprise at least one wall having any suitable and desired thickness. For example, the thickness of the at least one wall may be between 0.1 cm and 100 cm, e.g. between 0.5 cm and 50 cm, e.g. between 0.5 cm and 20 cm, e.g. between 0.5 cm and 10 cm, e.g. between 0.5 cm and 5 cm, e.g. between 0.5 cm and 3 cm, e.g. approximately 1 cm.

As outlined above, the reaction chamber may comprise a cavity (e.g. extending through the reaction chamber) through which the hydrocarbon fuel is flowed from the inlet to the outlet. The cavity may have a width (or diameter if the reaction chamber is cylindrical) of between 5 mm and 100 mm, e.g. between 10 mm and 80 mm, e.g. between 20 mm and 60 mm, e.g. between 20 and 40 mm. In some embodiments the cavity may have a constant (e.g. cross-sectional) size and shape along the length of the reaction chamber which is heated. In some embodiments, the cavity may have a variable (e.g. cross-sectional) size and shape along the length of the reaction chamber which is heated.

The ratio between the diameter (or width) of the cavity and the length of the reaction chamber (e.g. in embodiments where the reaction chamber is cylindrical (or prismatic) in shape) preferably ranges from 1:5 to 1:80, e.g. 1:5 to 1:60, e.g. 1:10 to 1:40, e.g. 1:10 to 1:20.

The electrically conducting coil comprises a length (i.e. the dimension (e.g. of the overall shape of the electrically conducting coil) horizontal to the longitudinal axis) such that the electrically conducting coil heats a portion of the reaction chamber of substantially the same length. The length of the reaction chamber heated (corresponding to the length of the electrically conducting coil) may be any suitable and desired length. For example, the length of the reaction chamber heated (or the length of the electrically conducting coil) may range from 10 cm to 10 m, e.g. 10 cm to 5 m, e.g. 20 cm to 1 m, e.g. 20 cm to 50 cm, e.g. 20 cm to 40 cm, e.g. 30 cm.

In a preferred embodiment, the reaction chamber is cylindrical with a 2.5 cm cavity diameter, a 0.8 cm reaction chamber wall (resulting in a reaction chamber total diameter of 3.3 cm) and a 30 cm length over which the reaction chamber is heated, such that the cavity volume in which pyrolytic decomposition occurs is approximately 94 cm³.

The apparatus is preferably arranged to heat the reaction chamber to temperatures in excess of 1,500° C., preferably greater than 1,800° C., e.g. 1,900-2,500° C., e.g. 2,000-2,400° C. This helps to effect pyrolytic decomposition of the hydrocarbon fuel. Thus, the reaction chamber preferably comprises or consists of (is substantially formed from) an electrically conducting material, e.g. capable of withstanding temperatures in excess of 2500° C., preferably in excess of 3000° C., preferably without undergoing phase transitions (e.g. melting). For example, the reaction chamber may comprise or consist of (is substantially formed from) suitable refractory metals (i.e. metals having a melting point above 2200° C.) such as tungsten, rhenium, tantalum, molybdenum, osmium and iridium. In some embodiments, the reaction chamber is made from tungsten, e.g. a tungsten cylinder or tube.

The coil is preferably formed as a continuous length of (i.e. electrically conducting) material wound to comprise a plurality of turns. For example, the electrically conducting material may be wound in a sequence of loops (i.e. non-circular turns) or rings (i.e. circular turns), wherein each turn within the coil shares a common axis.

The apparatus (e.g. for use in the method described herein) comprises an (e.g. at least one) electrically conducting coil surrounding a (e.g. at least one) reaction chamber and arranged to receive an alternating current. For example, the electrically conducting coil is connected to an alternating current generator arranged to supply an alternating current to the electrically conducting coil.

The method comprises passing an alternating current through an (e.g. at least one) electrically conductive coil arranged to surround the (e.g. at least one) reaction chamber such that an alternating magnetic field is generated to inductively heat the (e.g. at least one) reaction chamber. For example, the method comprises the electrically conducting coil receiving an alternating current from the alternating current generator and thus preferably the alternating current generator generating an alternating current and supplying the alternating current to the electrically conducting coil. The frequency of the alternating current may be between 500 Hz and 100 MHz, e.g. between 1 kHz and 500 kHz, e.g. between 10 kHz and 100 kHz, e.g. between 20 kHz and 90 kHz, e.g. between 30 kHz and 70 kHz, e.g. approximately 50 KHz.

In some embodiments, the (e.g. at least one) electrically conducting coil surrounds the (e.g. at least one) reaction chamber such that the length of the electrically conducting coil extends along or in parallel with the longitudinal axis. In some embodiments, the center of the electrically conducting coil and the center of the cross-sectional shape of the reaction chamber intersect such that they share a common axis (e.g. the electrically conducting coil and the (e.g. respective) reaction chamber are coaxial). In embodiments comprising a plurality of reaction chambers surrounded by a single coil, the reaction chambers may be arranged within the electrically conducting coil such that the center of the arrangement of (e.g. the shape formed by) the plurality of reaction chambers intersects the center of the coil such that they share a common axis along which the arrangement of reaction chambers and the length of the electrically conducting coil extends.

In some embodiments, the apparatus (e.g. for use in the method described herein) may comprise more than one electrically conducting coil, e.g. two or more electrically conducting coils, e.g. three or more electrically conducting coils, e.g. a plurality of electrically conducting coils. As described above, in some embodiments, there may be the same number of electrically conducting coils as there are reaction chambers, such that each reaction chamber is surrounded by a respective electrically conducting coil. In other embodiments, there may be fewer electrically conducting coils as there are reaction chambers, such that a plurality of reaction chambers are surrounded by a common coil. In other embodiments, there may be more electrically conducting coils than there are reaction chambers, such that each reaction chamber is surrounded by a plurality of electrically conducting coils, where the plurality of electrically conducting coils may be arranged adjacent or in series to each other along or in parallel with the longitudinal axis. In some embodiments, one or more reaction chambers is surrounded by two or more common electrically conducting coils, e.g. a plurality of reaction chambers are surrounded by at least two common electrically conducting coils.

The shape of the electrically conducting coil may be described by a first cross-sectional shape (i.e. defining the shape of the turns of the continuous length of material) and a second cross-sectional shape (i.e. defining the cross-sectional shape of the continuous length of material which is wound to form the coil). For example, a continuous length of a solid square pipe wound (e.g. wound round a cylinder) to have circular turns forms a coil has a circular first cross-sectional shape and a square second cross-sectional shape.

The first cross-sectional shape of the electrically conducting coil may comprise any suitable and desired shape, e.g. a circle, an oval, a square or a rectangle. It will be appreciated that, as the electrically conducting coil surrounds a reaction chamber, the first cross-sectional shape is hollow and thus defines a cavity inside which the reaction chamber is positioned. The plurality of turns of the electrically conducting coil may thus be considered to form the perimeter of the first cross-sectional shape.

As the electrically conducting coil surrounds the reaction chamber, the interior dimensions of the first cross-sectional shape (e.g. the width and height of the hollow area of the first cross-sectional shape) of the electrically conducting coil may not be smaller than the exterior dimensions (e.g. exterior width and height) of the reaction chamber defined by the reaction chamber wall(s). In some embodiments the interior dimensions of the first cross-sectional shape are equal to the exterior dimensions of the reaction chamber, such that the electrically conducting coil is in direct contact with the reaction chamber. In some embodiments the interior dimensions of the first cross-sectional shape are greater than the exterior dimensions of the reaction chamber, such that the electrically conducting coil is not in direct contact with the (e.g. at least one) reaction chamber.

The first cross-sectional shape of the coil relative to the reaction chamber may affect the thermal profile induced in the wall of the reaction chamber, when an alternating electric current is passed through the electrically conducting coil. It may be desirable to minimize the thermal variation across the width of a reaction chamber, to help provide even (or isotropic) heating of the hydrocarbon fuel passing therethrough. In some embodiments, the first cross-sectional shape (e.g. the shape of the turns) of the electrically conducting coil(s) corresponds to the shape of the reaction chamber it surrounds. For example, in embodiments comprising a single cylindrical reaction chamber, the reaction chamber may be surrounded by an electrically conducting coil having a circular first cross-section, and thus comprising circular turns (e.g. rings). A cuboid reaction chamber may, for example, be surrounded by a coil comprising square shaped turns.

In embodiments comprising a plurality of reaction chambers, the first cross-sectional shape (e.g. the shape of the turns) of the electrically conducting coil may correspond to the overall shape of the arrangement of reaction chambers within the coil. For example, in embodiments comprising three reaction chambers arranged parallel to the longitudinal axis in a triangle (e.g. each of the three reaction chambers at an apex of a triangle with the longitudinal axis at the center of the triangle) within the (e.g. hollow) center of an electrically conducting coil, the first cross-sectional shape of the coil may be substantially triangular (or a triangle with rounded corners).

In some embodiments, the first cross-sectional shape may not correspond to the shape of the reaction chamber which it surrounds. For example, regardless of the reaction chamber shape, the number of reaction chambers or the shape of the arrangement of a plurality of reaction chambers within the center of an electrically conducting coil, the electrically conducting coil may have a circular first cross-sectional shape, e.g. for ease of manufacture or commercial availability.

The second cross-sectional shape of the electrically conducting coil may comprise any suitable and desired cross-sectional shape, e.g. a circle, an oval, a square, a rectangle, a flattened oval, a D-shape or a trapezoid. For example, in one embodiment the electrically conducting coil has a circular second cross-sectional shape, such that the electrically conducting coil comprises a continuous length of a circular pipe or tube that is wound into the first cross-sectional shape to surround the reaction chamber(s).

The second cross-sectional shape may have any suitable and desired dimensions (e.g. width and height). In some embodiments, the width (i.e. the dimension parallel to the surface of the at least one wall) of the second cross-sectional shape ranges from 1 mm to 100 mm, e.g. 5 mm to 50 mm, e.g. 6 mm to 40 mm, e.g. 7 mm to 30 mm, e.g. 8 mm to 25 mm, e.g. 9 mm to 20 mm, e.g. 10 mm to 15 mm, e.g. 10 mm to 12 mm.

The continuous length of material may either be solid (e.g. the second cross-sectional shape is continuously filled) or hollow (e.g. the electrically conducting material forms only the perimeter or wall of the cross-sectional shape). In some embodiments, the electrically conducting coil comprises a high frequency (HF) cable, which comprises a solid (e.g. continuously filled second cross-sectional shape) length of metal (e.g. copper) material. In some such embodiments, the electrically conducting coil may be positioned within a conduit, which may provide cooling of the electrically conducting coil.

The apparatus may thus comprise a fluid supply in connection with the conduit such that fluid is supplied into the cavity of the conduit to surround the (e.g. high frequency cable of the) electrically conducting coil and provide cooling via heat transfer and thermal convection. For example, the conduit may comprise a coil shape that substantially matches the first and second cross-sectional shapes of the electrically conducting coil (with dimensions (e.g. width) that are larger than that of the electrically conducting coil such that the electrically conducting coil may be positioned within the conduit without touching the walls of the conduit). It will be appreciated that the fluid may be any suitable and desired fluid, e.g. liquid (e.g. water, liquid nitrogen) or gas.

In preferred embodiments, the electrically conducting coil comprises a hollow cavity, e.g. the electrically conducting length of material is hollow. In some such embodiments, the apparatus comprises a fluid supply in connection with the electrically conducting coil for supplying a fluid into the hollow cavity of the electrically conducting coil, to provide cooling of the electrically conducting coil. It will be appreciated that the fluid may be any suitable and desired fluid, e.g. liquid (e.g. water, liquid nitrogen) or gas.

In some embodiments the apparatus comprises a cooling conduit (e.g. separate from the electrically conducting coil) in thermal contact with the electrically conducting coil, and a fluid supply for supplying a fluid to the cooling conduit, to provide cooling of the electrically conducting coil. The cooling conduit may, for example, be in thermal contact with the electrically conducting coil along the length of the electrically conducting material forming the electrically conducting coil. Thus, for example, the cooling conduit may follow substantially the same path as the electrically conducting coil.

The fluid supply may be connected to the electrically conducting coil or the cooling conduit at any suitable and desired point along the electrically conducting coil or the cooling conduit. In some embodiments, the fluid supply is connected such that the fluid flows through the electrically conducting coil or the cooling conduit in a direction parallel and/or equal to the direction of the hydrocarbon fuel flowing from the inlet to the outlet. In some embodiments, the fluid supply is connected such that the fluid flows through the electrically conducting coil or the cooling conduit in a direction parallel but opposite to the flow of the hydrocarbon fuel passing from the inlet to the outlet. In some embodiments, the fluid supply is connected to the electrically conducting coil or the cooling conduit at a midpoint between the start and end of the coil such that fluid flows through the electrically conducting coil or the cooling conduit in more than one direction with respect to the flow of the hydrocarbon fuel.

As the electrically conducting coil surrounds the reaction chamber, some of the heat generated at the (e.g. at least one) reaction chamber may radiate outwards from the reaction chamber towards the electrically conducting coil, resulting in an increasing temperature of the electrically conducting coil. As such, cooling of the electrically conducting coil by passing a fluid through the center of the coil or the cooling conduit mitigates the increased thermal environment and thus prevents the material of the electrically conducting coil undergoing any undesirable phase transitions, e.g. melting. In some embodiments, the method (e.g. using the apparatus described herein) comprises passing a fluid through the (e.g. at least one) electrically conducting coil or the cooling conduit to cool the electrically conducting coil.

The thickness of the material forming the perimeter or wall of the second cross-sectional shape may be any suitable and desired thickness. For example, the thickness of may range from 500 μm to 50 mm, e.g. 1 mm to 30 mm, e.g. 1 mm to 20 mm, e.g. 1 mm to 10 mm, e.g. 1 mm to 5 mm, e.g. 1 mm to 34 mm, e.g. 1 mm to 3 mm.

In some embodiments, each turn of the plurality of turns forming the electrically conducting coil may have the same dimensions or may have different dimensions along the length of the electrically conducting coil. For example, in some embodiments, the turns of the electrically conducting coil may form a spiral (e.g. the turns may be continuously increasing (or decreasing) in size round a common central point or axis, such that each successive turn has increasing or decreasing interior dimensions (i.e. width, height or radii) with respect to the previous turn). It will be appreciated that the shape of the spiral will correspond to the first cross-sectional shape of the electrically conducting coil. For example, an electrically conducting coil having a circular first cross-sectional shape may be wound into a circular spiral (e.g. a sequence of continuous and increasing curved turns). For example, an electrically conducing coil having a square first cross-sectional shape may be wound into a square spiral (e.g. a sequence of continuous and increasing 90° turns).

The electrically conducting coil may form any suitable and desired (e.g. three-dimensional) shape. The (three-dimensional) shape may be described by the first cross-sectional shape of the electrically conducting coil and a length (i.e. the dimension (e.g. of the overall shape of the electrically conducting coil) parallel to the longitudinal axis) which, e.g., corresponds to the length of the reaction coil that is heated by the surrounding electrically conducting coil when an alternating current is passed through the electrically conducting coil. The (e.g. three-dimensional) shape may be considered to be the overall shape around which the electrically conducting coil could be considered to be wound. For example, the (three-dimensional) shape corresponds to the (three-dimensional) shape of the volume of the cavity (e.g. inside which the reaction chamber is positioned) surrounded by the electrically conducting coil.

In some embodiments, the electrically conducting material of the electrically conducting coil may form a continuous wall of the (e.g. three-dimensional) shape. For example, when successive turns of the electrically conducting coil are wound to be in direct contact, there is substantially no space between the turns of the electrically conducting coil and the coil substantially forms a solid wall around the cavity volume. In some embodiments, the electrically conducting material forms a discontinuous wall of the (e.g. three-dimensional) shape, for example, when successive turns of the electrically conducting coil are wound such that they are not in direct contact.

For example, the electrically conducting coil may form a toroid (e.g. donut), a (e.g. hollow) cylinder, a (truncated) prism (e.g. any polygon-based prism, e.g. triangular based, e.g. square-based prism, etc.), a (truncated) pyramid (e.g. a pyramidal shape with any suitable polygon base, e.g. a trilateral pyramid, a quadrilateral pyramid, etc.), a (truncated) conical shape, and so on.

For example, an electrically conducting coil with spiral turns (as described above), may have each successive turn (e.g. which continuously increases (or decreases) in size) in substantially the same plane, e.g. a plane substantially perpendicular to the longitudinal axis, such that the electrically conducting coil forms toroid or donut of electrically conducting material. Preferably, the center of the toroid intersects with the longitudinal axis.

For example, an electrically conducting coil with spiral turns (as described above), may form a (truncated) pyramidal or conical shape, wherein the length (e.g. the height of the pyramid, e.g. the distance from the two parallel bases in a truncated pyramid or cone) of the pyramid is parallel (e.g. coaxial) with the longitudinal axis.

For example, an electrically conducting coil with a plurality of turns all having substantially the same interior dimensions (i.e. width, height or radii) may form a cylindrical or any polygon-based prismatic shape (e.g. having a consistently dimensioned cross-section), wherein the length (e.g. the distance between the two parallel polygon bases) of the cylinder or prism is parallel (e.g. coaxial) with the longitudinal axis. For example, the electrically conducting coil is a uniformly dimensioned spring coil with a substantially constant cylindrical interior volume along (in parallel, e.g. coaxial) with, the longitudinal axis.

The (e.g. three-dimensional shape of the) electrically conducting coil may have any suitable and desired length in the direction parallel to the longitudinal axis. The length of the reaction chamber surrounded by the electrically conducting coil may be considered to substantially correspond to a length of the reaction chamber that is heated directly by induction, e.g. a heated portion.

It will be appreciated that the length of the heated portion (e.g. corresponding to the length of the electrically conducting coil) should be such that the reaction chamber is heated to a sufficient temperature for the hydrocarbon fuel to undergo pyrolytic decomposition. The heated portion of the reaction chamber may be any suitable and desired length.

The length of the (e.g. three-dimensional) shape of the electrically conducting coil may range from 5 mm to 10 m, e.g. 1 cm to 10 m, e.g. 5 cm to 5 m, e.g. 10 cm to 5 m, e.g. 20 cm to 1 m, e.g. 20 cm to 50 cm, e.g. 20 cm to 40 cm, e.g. 30 cm. It will be appreciated that the total length of the coil depends on parameters including the width of the first cross-sectional shape, the number of turns and the coil pitch and/or the spacing between turns.

It will also be appreciated that the total length of the coil depends on the scale, size and implementation of the apparatus. For example, in some embodiments the apparatus may be implemented on an industrial scale (e.g. intended for use in an industrial plant for the pyrolytic decomposition of large volumes of hydrocarbon fuel on an industrial scale) and thus may comprise an electrically conducting coil (and reaction chamber) having a length of greater than 1 m, e.g. between 1 m and 10 m (or larger). In other embodiments, the apparatus may be implemented on a smaller scale (e.g. for the pyrolytic decomposition of small, e.g. domestic, volumes of hydrocarbon gas) such that a more suitable length of the electrically conducting coil would be between 10 cm and 50 cm.

In some embodiments, adjacent turns of the electrically conducting coil are in direct contact such that the spacing between the electrically conducting material of adjacent turns is negligible (e.g. substantially zero) and the coil pitch (i.e. distance between turns) is substantially equal to the width of the second cross-sectional shape. In preferred embodiments, the turns of the electrically conducting coil are not in direct contact such that the coil pitch is greater than the width of the second cross-sectional shape and there is a (i.e. non-zero) spacing between each turn of the electrically conducting material.

In some embodiments, the spacing between adjacent turns of the electrically conducting coil ranges from between 0.01 mm and 1 m, e.g. between 0.5 mm and 50 cm, e.g. between 1 mm and 25 cm, e.g. between 1 mm and 10 cm. depending on the scale, size and implementation of the apparatus. For example, an apparatus implemented on a small scale (e.g. for domestic use) may comprise a spacing between adjacent turns of the electrically conducting coil of between 0.01 mm and 50 mm, e.g. between 0.5 mm and 40 mm, e.g. between 1 mm and 30 mm, e.g. between 1 mm and 20 mm, e.g. between 1 mm and 15 mm, e.g. between 1 mm and 10 mm, e.g. approximately 5 mm.

An apparatus implemented on a large scale (e.g. for industrial use) may have a spacing between adjacent turns of the electrically conducting coil of between 10 mm and 1 m, e.g. between 50 mm and 50 cm, e.g. 1 cm to 25 cm, e.g. between 5 cm and 20 cm, e.g. approximately 10 cm.

In some embodiments, the coil pitch (i.e. the distance between turns) is between 5 mm and 5 m, e.g. between 10 mm and 1 m, e.g. between 1 cm and 50 cm. It will be appreciated that the coil pitch is dependent on numerous parameters including the width of the first cross-sectional shape, the number of turns, the spacing between turns and the size, scale and implementation of the apparatus. For example, in one set of embodiments (e.g. wherein the apparatus is implemented on a small scale), the coil pitch is between 5 mm and 30 mm, e.g. between 6 mm and 25 mm, e.g. between 7 mm and 20 mm, e.g. between 8 mm and 15 mm, e.g. between 10 mm and 15 mm, e.g. between 12 mm and 14 mm, e.g. approximately 13 mm. In a set of embodiments (e.g. wherein the apparatus is implemented on a large and/or industrial scale) the coil pitch may be between 10 cm and 5 m, e.g. between 50 cm and 5 m, e.g. between 1 m and 5 m.

In some embodiments, the electrically conducting coil comprises or consists of a metal or metal alloy, e.g. including but not limited to copper, silver, gold, aluminum, steel, brass, zinc, iron, nickel, tin or bronze.

The electrically conducting coil may comprise any suitable and desired number of turns, e.g. between 2 and 1000 turns, e.g. between 5 and 500 turns, e.g. between 10 and 400 turns, e.g. between 10 and 300 turns, e.g. between 10 and 200 turns, e.g. between 10 and 100 turns, e.g. between 10 and 50 turns, e.g. approximately 20 turns. It will be appreciated that the number of turns will depend on parameters including the spacing between turns, the coil pitch and the size, scale and implementation of the apparatus.

In some embodiments, the apparatus (e.g. for use in the method described herein) comprises a plurality of electrically conducting coils adjacent to one another, e.g. arranged (e.g. in series) along or in parallel with the longitudinal axis. A plurality of electrically conducting coils helps to provide an improved thermal efficiency than a single electrically conducting coil having the same total number of turns as the plurality of electrically conducting coils.

In some embodiments, the apparatus (e.g. for use in the method described herein) comprises a (e.g. at least one) pair of electrically conducting coils wherein each pair of electrically conducting coils comprises two electrically conducting coils arranged to receive the (e.g. same, e.g. different) alternating current. In some embodiments, both electrically conducting coils in the pair of electrically conducting coils comprises the same number of turns. In some embodiments, both electrically conducting coils in the pair of electrically conducting coils comprises a different number of turns In some embodiments comprising a pair of electrically conducting coils, each pair of electrically conducting coils comprises one coil having left handed turns and one coil having right handed turns such that the two coils may branch from a common component and turn outward from said branching point to extend in opposite directions parallel to the surface of the reaction chamber.

A pair of electrically conducting coils may comprise a common line (e.g. of electrically conducting material) such that both electrically conducting coils may receive the alternating electric current and/or the fluid supply input through the common line. The common line may split at a branch point (e.g. at the center of the reaction chamber) to form the pair of electrically conducting coils. For example, the electrically conducting coils may extend outwardly from that branch point to form each electrically conducting coil in the pair. In such embodiments, the pair of electrically conducting coils may be fluid cooled and preferably the fluid supply is connected to the center of the reaction chamber (and thus in between the pair of electrically conducting coils). This helps to create the most optimized thermal conditions at the center of the reaction chamber (e.g. it will be appreciated that water-cooling may be less effective after the fluid has passed through some length of a hot electrically conducting coil).

In some embodiments, the apparatus (e.g. for use in the method described herein) comprises an (e.g. thermal) insulating layer surrounding the reaction chamber. In some embodiments, insulating layer is between the (e.g. at least one) reaction chamber and the electrically conducting coil(s). In some embodiments, the electrically conducting coil is (at least partially) embedded within the insulating layer.

The (e.g. thermal) insulating layer may be in direct contact with the reaction chamber. The (e.g. thermal) insulating layer may be in direct contact with both the reaction chamber and the (e.g. at least one) electrically conducting coil. In embodiments comprising a plurality of reaction chambers, each of the (e.g. at least one) reaction chambers may have an (e.g. thermal) insulating layer that is in direct contact with and surrounds the reaction chamber, such that the (e.g. thermal) insulating layer comprises the same cross-sectional shape as the reaction chamber. In some embodiments comprising a plurality of reaction chambers surrounded by a common electrically conducting coil (or pair of electrically conducting coils), the (e.g. thermal) insulating layer may be arranged to surround the plurality of reaction chambers (e.g. the plurality of reaction chambers have a common insulating layer) in addition to or instead of surrounding each individual reaction chamber with an (e.g. different) insulating layer.

The (i.e. thermal) insulating layer is preferably arranged to thermally insulate the reaction chamber, such that heat generated at the reaction chamber by induction is inhibited from radiating outwardly from the reaction chamber towards the electrically conducting coil(s) surrounding the electrically conducting coil(s) and the insulating layer. By providing the insulating layer between the electrically conducting coil(s) and the reaction chamber, the thermal efficiency of the apparatus may be improved because the radiation of heat is focused towards the center of the reaction chamber (i.e. the cavity comprising the hydrocarbon gas). In preferred embodiments, the insulating layer allows the penetration of the alternating magnetic field into the reaction chamber wall such that inductive heating arises substantially unhindered.

In embodiments comprising a reaction chamber consisting or comprising of a material capable of undergoing oxidation (e.g. metals), providing an (i.e. thermal) insulating layer may help to inhibit the oxidation of the material and thus the formation of oxide on the surface of the wall(s) of the reaction chamber when heated to the temperatures used for pyrolytic decomposition. For example, tungsten, at temperatures required for pyrolytic decomposition, undergoes oxidation to form tungsten oxide at the surface. Thus, the provision of an insulation layer helps to mitigate this effect.

In some embodiments, the insulating layer helps to improve the heating efficiency of the apparatus (e.g. the amount of heat transferred to the hydrocarbon fuel divided by the amount of heat generated by the electrically conducting coil in the wall of the reaction chamber) by at least 80% (e.g. for every 10 KW of thermal energy generated in the reaction chamber walls by induction, 2 KW of energy is radiated toward the insulating layer and electrically conducting coil). Preferably, the insulation layer improves the heating efficiency of the apparatus by at least 85%, e.g. at least 90%, e.g. at least 95%.

The insulating layer may comprise any suitable and desired thermally insulating material. For example, the insulating layer may comprise any mineral wool (e.g. stone wool) and/or any thermally insulating ceramic material, such as ultra-high temperature ceramics, including, but not limited to, tantalum carbide, TaC, hafnium carbide, HfC, zirconium diboride ZrBr₂, hafnium diboride, HfBr₂ and zirconium oxide, ZrO₂ and composites thereof including composites with silicon carbide.

In some embodiments, the insulating layer comprises a plurality of layers, e.g. at least one layers of an ultra-high temperature ceramic and at least one layer of a ceramic fiber felt. For example, the insulating layer may comprise a first layer of ceramic fiber felt and a second layer of ultra-high temperature ceramic, wherein the second layer is outer of (e.g. closer to the electrically conducting coil than) the first layer, e.g. the second layer is at the outermost edge of the insulating layer, e.g. forming the surface of the insulating layer. In some embodiments, the insulating layer comprises a first region of a ceramic fiber felt composite (e.g. alternating layers of ceramic fiber felt with layers of ultra-high temperature ceramic disposed therebetween) and a second region consisting of a layer of ultra-high temperature ceramic, wherein the second layer is outer of (e.g. closer to the electrically conducting coil than) the first layer, e.g. the second layer is at the outermost edge of the insulating layer.

In some embodiments, the insulating layer may comprise a plurality of ceramic fiber felt layers and a plurality of ultra-high temperature ceramic layers wherein each ceramic fiber felt layer is sandwiched between (e.g. two) ultra-high temperature ceramic layers. For example, in a preferred embodiment, the insulating layer comprises a plurality of layers of ceramic fiber felt with layers of zirconium oxide, ZrO₂ disposed therebetween, with the outer layer of the insulating layer comprising a layer of ZrO₂.

The insulating layer may have any suitable and desired thickness. For example, the insulating layer may have a total thickness of between 0.1 mm and 50 mm, e.g. between 0.5 mm and 30 mm, e.g. between 1 mm and 20 mm, e.g. between 1 mm and 150 mm, e.g. between 1 and 5 mm. In embodiments wherein the insulating layer comprises at least one layer of ceramic fiber felt, each layer of ceramic fiber felt may have a thickness of between 1 mm and 10 mm, e.g. between 1 mm and 5 mm. In some embodiments, the outermost layer of the insulating layer is a layer of ultra-high temperature ceramic (e.g. ZrO₂) preferably having a thickness of between 0.1 mm and 5 mm, e.g. between 0.5 mm and 3 mm, e.g. between 0.5 mm and 2 mm.

In some embodiments, the electrically conducting coil (or pair of electrically conducting coils) may be in direct contact with the insulating layer, e.g. the turns of the coil are wound onto the insulating layer. In some embodiments, the electrically conducting coil is (at least partially) embedded within the insulating layer (i.e. the insulating layer surrounds the electrically conducting coil) In some embodiments, the electrically conducting coil is not in direct contact with (e.g. spaced from) the insulating layer. In such embodiments, the lack of direct contact between the insulating layer and the electrically conducting coil may help to prevent or reduce electrical conduction through the insulating layer.

In some embodiments, the apparatus (e.g. for use in the method described herein) comprises a housing that encloses the (e.g. at least one) reaction chamber and the electrically conducting coil(s). Preferably the housing comprises an inlet for supplying the hydrocarbon fuel to the inlet of the reaction chamber and an outlet in fluid communication with and downstream of the outlet of the reaction chamber. In some embodiments, the inlet and outlet of the housing is contiguous or continuous with the inlet and outlet of the reaction chamber. In some embodiments, a continuous conduit (e.g. a pipe) is provided through the reaction chamber wherein the continuous conduit comprises the outlet and outlet of the housing, the inlet and outlet of the reaction chamber and the reaction chamber.

The housing may be arranged to provide an environment around the (e.g. at least one) reaction chamber that is modified with respect to atmospheric conditions, i.e. a non-atmospheric environment. For example, the apparatus may comprise a vacuum line (e.g. connected to a vacuum pump) connected to the housing, wherein the vacuum line is arranged to reduce the pressure within the housing (i.e. around the reaction chamber and the electrically conducting coil) to below atmospheric pressure, e.g. to establish at least a partial vacuum environment.

In some embodiments, the apparatus comprises a pump connected to the housing and arranged to maintain a pressure inside the housing above atmospheric pressure. In some embodiments, the apparatus comprises a gas supply connected to the housing (e.g. via a gas inlet line), wherein the gas supply is arranged supply a flow of gas to the housing, e.g. to reduce the oxygen content of the gaseous environment inside the housing (and surrounding the reaction chamber) relative to atmospheric conditions, e.g. to make the environment inside the housing substantially free of oxygen.

In some embodiments, the gas supply is arranged to supply a (e.g. substantially constant) flow of gas to the housing to displace gas (e.g. oxygen) within the housing and surrounding the reaction chamber. In some preferred embodiments, the gas supply comprises a nitrogen gas supply, e.g. arranged to supply a substantially constant stream of nitrogen into the housing to surround the reaction chamber and displace any oxygen present within the housing, to provide a substantially oxygen free environment.

In embodiments comprising a reaction chamber consisting or comprising of a material capable of undergoing oxidation (e.g. metals), providing a substantially oxygen free environment may inhibit the oxidation (e.g. formation of a metal oxide) of the surface of the reaction chamber when heated to the temperatures used for pyrolytic decomposition of a hydrocarbon. For example, a reaction chamber consisting or comprising of tungsten, in the presence of oxygen at the temperatures used for pyrolytic decomposition of a hydrocarbon, may undergo oxidation to form tungsten oxide on the surface of the reaction chamber.

The method (e.g. using the apparatus as described herein) may therefore comprise providing a non-atmospheric environment (e.g. an environment that is modified with respect to at least one atmospheric condition such as atmospheric pressure and/or the gaseous composition of air) around the reaction chamber (e.g. within a housing that encloses the reaction chamber). In some embodiments, the method comprises providing a low pressure environment around the reaction chamber, for example, by connecting the housing surrounding the reaction chamber to a vacuum line.

In some embodiments, the method comprises providing a high pressure environment around the reaction chamber, for example, by connecting the housing surrounding the reaction chamber to a pressure pump. In some embodiments, the method comprises providing an oxygen poor (e.g. substantially oxygen free) environment around the reaction chamber, for example by introducing an (e.g. inert, e.g. N₂) gas into the housing surrounding the reaction chamber (e.g. such that the oxygen surrounding the reaction chamber is displaced by the (e.g. inert, e.g. N₂) gas). In such embodiments, the gas introduced into the housing may be argon, helium, krypton, xenon, neon or nitrogen gas.

In some embodiments, the apparatus (e.g. for use in the method described herein) further comprises a thermal sensor (e.g. a pyrometer, e.g. thermal camera) arranged to measure the temperature of the reaction chamber, e.g. at a position between the reaction chamber inlet and the reaction chamber outlet. Preferably, the apparatus comprises two or more thermal sensors.

In some embodiments, the thermal sensor is arranged to measure the temperature of the reaction chamber at a position which is heated by the surrounding electrically conducting coil, e.g. a position along the length of the heated portion of the reaction chamber, i.e. a part of the reaction chamber that is surrounded by (e.g. at least part of) the electrically conducting coil and thus experiences direct heating by induction. In some embodiments the thermal sensor comprises a pyrometer or a thermal camera arranged to detect (i.e. infrared) radiation (e.g. emitted or reflected from the reaction chamber), to measure the temperature of a surface (e.g. of the reaction chamber) from which the radiation is emitted.

In some embodiments, a pyrometer or thermal camera may be arranged to detect the thermal (i.e. infrared) radiation radiating from the reaction chamber surface as a consequence of the induction heating. In some embodiments, the pyrometer is arranged to output a beam of (i.e. infrared) radiation towards the target surface (e.g. the reaction chamber surface) and to use (e.g. detect and measure) the reflected beam to determine the temperature of the target surface. In such embodiments, the (i.e. infrared) radiation beam may be aligned to pass through the spacing between two turns of the electrically conducting coil, to reach the reaction chamber surface without coming into contact with (and thus being partially reflected from) the coil.

When the apparatus comprises an insulating layer, preferably the insulating layer comprises a (e.g. at least one) via. Vias help to provide a means by which the (i.e. infrared) radiation beam may contact the surface of the reaction chamber instead of the insulation layer surface. Similarly, in embodiments where the temperature measurement is conducted using the radiated (i.e. infrared) radiation emitted from the reaction chamber surface as a consequence of the inductive heating, it will be appreciated that vias through the insulation layer allow an accurate reading of the radiation emitted from the reaction chamber surface without interference of the measurement from the insulating layer.

In some embodiments, the apparatus (e.g. for use in the method described herein) comprises (e.g. at least) two thermal sensors arranged to measure the temperature at two different positions along the length of the reaction chamber. For example, in one embodiment, the apparatus (e.g. for use in the method described herein) comprises two pyrometers arranged to measure the temperature of the reaction chamber at substantially the center of the length of the reaction chamber (by one thermal sensor) and at a position downstream of the center of the length of the reaction chamber (by a second thermal sensor).

It will be appreciated that measuring the temperature of the reaction chamber in (e.g. at least) one place (preferably two or more) may result in a number of improvements. In particular, the temperature measurement provides an indirect measure of the induction heating efficiency and effectiveness. For example, by measuring the temperature of the heated portion of the reaction chamber at (e.g. at least) one position it may be identified that the alternating current needs to be modified, e.g. the temperature is too low and thus the current needs to be increased or vice versa.

In some embodiments, the apparatus (e.g. for use in the method described herein) comprises a control unit arranged to receive a temperature measurement from the thermal sensor and output a control signal (e.g. to the alternating current generator), to vary the current of the alternating current supplied to the electrically conducting coil. It will be appreciated by changing the current of the alternating current, the magnitude of the magnetic field generated by the electrically conducting coil may be increased or decreased and thus the heat generated at the reaction chamber may in turn be increased or decreased, in response to the measured temperature of the reaction chamber.

The method thus further comprises measuring the temperature of the reaction chamber at a position along the reaction chamber that is heated, i.e. a position that is surrounded by the electrically conducting coil. The temperature of the reaction chamber may thus be compared to a pre-set desired temperature range, e.g. the preferred range at which pyrolytic decomposition occurs. The desired temperature range preferably comprises an upper limit (i.e. defining an uppermost acceptable temperature, e.g. the temperature at which the reaction chamber wall(s) may begin to melt) and a lower limit (i.e. defining a lowermost acceptable temperature, e.g. the temperature below which pyrolytic decomposition has a conversion efficiency of less than 80%, e.g. less than 85%, e.g. less than 90%). In some embodiments the desired temperature range is between 1,800° C. (lower limit) and 2,400° C. (upper limit), e.g. between 1,900° C. and 2,300° C., e.g. between 2,000° C. and 2,200° C.

In some embodiments, the method further comprises determining when the temperature of the reaction chamber is below a lower limit of a desired temperature range and changing the current of the alternating current passing through the electrically conducting coil to increase the heat generated in the reaction chamber, e.g. by transmitting a control signal to the alternating current generator.

In some embodiments, the method further comprises determining when the temperature of the reaction chamber is above an upper limit of a desired temperature range and changing the current of the alternating current passing through the electrically conducting coil to decrease the heat generated in the reaction chamber, e.g. by transmitting a control signal to the alternating current generator.

By measuring the temperature of the reaction chamber at (e.g. at least) two positions, it helps to determine how efficiently the pyrolytic decomposition process is occurring. For example, it will be appreciated that the process of pyrolytic decomposition is endothermic and thus involves the absorption of thermal energy to break the bonds of the hydrocarbon fuel. As a result, it will be appreciated that the pyrolytic decomposition is accompanied by thermal quenching (e.g. cooling) of the decomposing hydrocarbon fuel stream.

By measuring the temperature of the heated portion of the reaction chamber at a position substantially at the center of the reaction chamber, as well as a position downstream from the center of the reaction chamber (e.g. a position downstream of the center that is still surrounded by the electrically conducting coil and/or a position of the reaction chamber downstream from the center that is not surrounded by the electrically conducting coil and thus not directly heated), the extent of thermal quenching may be measured and thus the thermal efficiency may be calculated as well as the efficiency with which the hydrocarbon fuel is converted to the pyrolytic decomposition products.

In some embodiments, the control unit is arranged to receive a plurality of temperature measurements from a plurality of thermal sensors and output a control signal (e.g. to the alternating current generator) in response to the measurements to vary the current of the alternating current received by the electrically conducting coil.

The method thus further comprises measuring the temperature of the reaction chamber at (e.g. at least) two different positions along the reaction chamber. The temperature of each position along the reaction chamber may thus be compared to a pre-set desired temperature range for that position, e.g. the preferred range at which pyrolytic decomposition occurs at a central position of the reaction chamber, e.g. the desired range of the downstream products after quenching. As described above the desired temperature range at every position preferably comprises an upper limit and a lower limit.

The upper limit and lower limits of each position may be different depending on the process being monitored. For example, as described above, the temperature at a heated portion of the reaction chamber may have an upper limit defined as the temperature at which the reaction chamber wall(s) may begin to melt and a lower limit defined by the temperature below which pyrolytic decomposition has a conversion efficiency of less than 80%, e.g. less than 85%, e.g. less than 90%.

In contrast, the desired temperature range at a position downstream of the heated portion of the reaction chamber (e.g. measuring the extent of thermal quenching) may have an upper limit defined by the minimum temperature which indicates at least 80% conversion efficiency and thus 80% automatic quenching (e.g. 85% conversion efficiency, e.g. 90% conversion efficiency), and a lower limit defined by the temperature at which the hydrocarbon fuel has been at least 90% converted (e.g. 95% converted, e.g. 100% converted) and thus there has been at least 90% thermal quenching (e.g. 95% thermal quenching, e.g. 100% thermal quenching) where 100% thermal quenching would correspond to 100% conversion of the hydrocarbon fuel to the plurality of products and thus observe the maximal temperature loss due to quenching.

In some embodiments, the method comprises determining when the temperature of the reaction chamber at a set position is below the lower limit of a desired temperature range for that position. In some embodiments, the method further comprises transmitting a control signal (e.g. to the alternating current generator) to change the current of the alternating current passing through the electrically conducting coil if it is determined that the temperature is below the lower limit, e.g. to alter the heat generated in the reaction chamber.

In some embodiments, the method further comprises determining when the temperature of the reaction chamber at a set position is above an upper limit of a desired temperature range for that position. In some embodiments, the method further comprises transmitting a control signal (e.g. to the alternating current generator) to change the current of the alternating current passing through the electrically conducting coil if it is determined that the temperature is above the upper limit, e.g. to alter the heat generated in the reaction chamber.

In some embodiments, the housing comprises a housing unit for the (e.g. at least) one thermal temperature sensor (e.g. pyrometer). The housing unit preferably comprises an alignment mechanism to adjust the position and/or orientation of the temperature sensor (or the output radiation beam), to align the sensor with respect to the desired target position on the reaction chamber (e.g. a position between coil turns and passing through a via in the insulation layer, if present). In some embodiments, the housing may comprise a viewing window or viewing port through which a visual inspection of the alignment of the temperature sensor may be obtained.

The present invention also extends to a system comprising an apparatus according to the any of the aspects described herein and any or all of the embodiments thereof, and a (e.g. at least one) downstream filter chamber comprising a filter for collecting and separating the products of the pyrolytic decomposition, wherein the filter is in fluid communication and downstream of the (e.g. at least one) outlet of the apparatus. The filter may be arranged to separate the solid (e.g. carbonaceous products) from the gaseous (e.g. hydrogen) products.

The method may thus further comprise the step of collecting the plurality of products from the pyrolytic decomposition of the hydrocarbon fuel. For example, the method may comprise separating the gaseous products (e.g. hydrogen gas) from the solid (e.g. carbonaceous) products by, for example, passing the products of the pyrolytic decomposition of the hydrocarbon fuel through a (e.g. at least one) filter.

As will be appreciated by those skilled in the art, the system can and preferably does include any one or more or all of the preferred and optional features of the invention described herein, as appropriate. For example, the reaction chamber preferably comprises or consists of an electrically conducting material capable of withstanding temperatures in excess of 2500° C., preferably in excess of 3000° C., without undergoing phase transitions (e.g. melting). For example, the reaction chamber may comprise or consist of suitable refractory metals (i.e. metals having a melting point above 2200° C.) such as tungsten, rhenium, tantalum, molybdenum, osmium and iridium.

As discussed above, the pyrolytic decomposition of a hydrocarbon fuel is an endothermic process that results in an automatic quenching (i.e. cooling) of the hydrocarbon fuel during the decomposition reaction. However, the temperature of the products on leaving the reaction chamber will be appreciated to be very high (e.g. in excess of 1800° C.). As such, it may be helpful to quench (or cool) the decomposition products before collecting or separating the products for further use.

In some embodiments, the system further comprises a quenching chamber in fluid communication with and downstream of the (e.g. at least one) outlet of the reaction chamber. The quenching chamber may be arranged to cool the hot pyrolytic decomposition products output by the reaction chamber in any suitable and desired way. For example, in some embodiments the quenching chamber comprises a heat exchanger, e.g. containing a coolant, such that quenching arises by heat exchange.

In some embodiments, the quenching chamber comprises a jacket surrounding the (e.g. portion of the) quenching chamber through which the products flow, wherein the jacket contains the coolant. In some embodiments, the quenching chamber comprises a coolant supply for supplying the coolant into the cooling jacket (e.g. a liquid coolant) or into the quenching chamber itself (e.g. a gaseous coolant), to provide cooling. In some embodiments, the quenching chamber comprises a pressure release mechanism (e.g. a pressure relief valve) arranged to effect a reduction in pressure with respect to the pressure within the reaction chamber such that the products are cooled via polytropic or isentropic cooling.

The method may thus comprise the method step of cooling the products of the pyrolytic decomposition of the hydrocarbon fuel, for example, by introducing the products of the pyrolytic decomposition into a quenching chamber downstream of the outlet of the reaction chamber. In some embodiments, the method may comprise introducing a coolant downstream into (e.g. to mix with the products of the pyrolytic decomposition) or around (e.g. into a jacket surrounding) the quenching chamber such that the coolant provides cooling to the products. In some embodiments, the method may comprise reducing the pressure of the quenching chamber with respect to the pressure of the reaction chamber such that the products are cooled via polytrophic or isentropic cooling.

### BRIEF DESCRIPTION OF THE DRAWINGS

Certain preferred embodiments for the invention will now be described, by way of example only, with reference to the accompanying drawings in which:

FIG. 1 shows a system in accordance with an embodiment of the present invention;

FIG. 2 shows the housing in accordance with an embodiment of the present invention;

FIG. 3 shows a three-dimensional cutaway representation of an apparatus for the pyrolytic decomposition of hydrocarbon fuel in accordance with an embodiment of the present invention;

FIG. 4 shows a side-view of an apparatus for the pyrolytic decomposition of hydrocarbon fuel in accordance with an embodiment of the present invention;

FIG. 5 shows a cross-sectional view (in a plane perpendicular to the longitudinal axis) of an apparatus in accordance with an embodiment of the present invention; and

FIG. 6 shows a cross-sectional view (in a plane parallel to the longitudinal axis) of an apparatus in accordance with an embodiment of the present invention.

Embodiments of the present invention will now be described that provide the components of the improved method and apparatus for the pyrolytic decomposition of hydrocarbon fuels.

### DETAILED DESCRIPTION

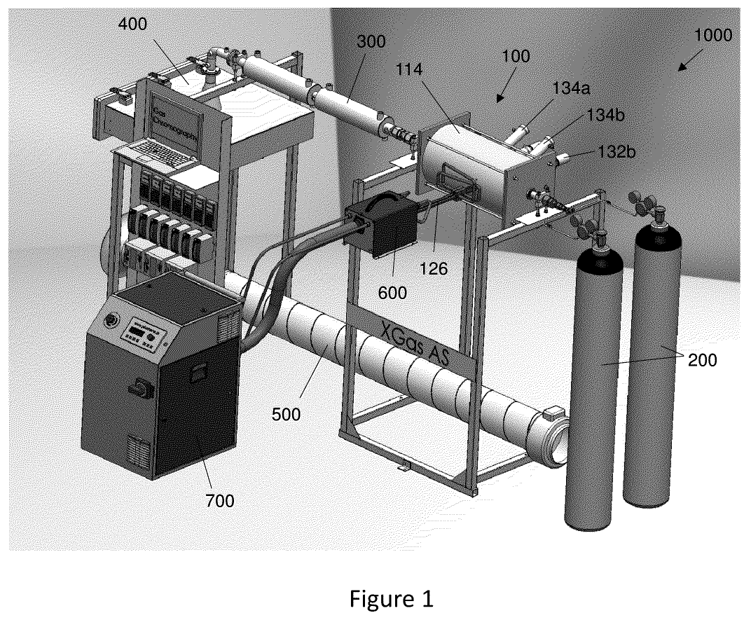

FIG. 1 shows a system 1000 in accordance with an embodiment of the present invention. The system 1000 shown includes an apparatus 100 (for the pyrolytic decomposition of the hydrocarbon fuel) in communication with a plurality of gas cylinders 200 arranged to supply the hydrocarbon fuel to the reaction chamber and nitrogen gas to the housing 114 to provide an oxygen poor environment within the housing 114; a quenching chamber 300 in communication with and downstream of the outlet of the reaction chamber; a filter chamber 400 in communication with and downstream of the quenching chamber to separate the gaseous products (e.g. hydrogen gas) from the solid (e.g. carbonaceous products); and a mixing chamber 500.

The apparatus 100 includes two lengths of electrically conducting material 126 extending into the housing 114 and connected to the convertor box (C-box) 600 which in turn is connected to an electricity supply and a fluid supply. The fluid supply supplies the cooling fluid (e.g. water) to the hollow cavity within the electrically conducting coil through the input and output of the lengths of material 126 (i.e. to provide fluid cooling to the electrically conducting coil). The two lengths of material 126 thus correspond to the input and output of the electrically conducting coil which is arranged to surround the reaction chamber (not shown) within the housing 114. The C-box 600 is connected to an induction unit 700 which supplies electricity to the C-box.

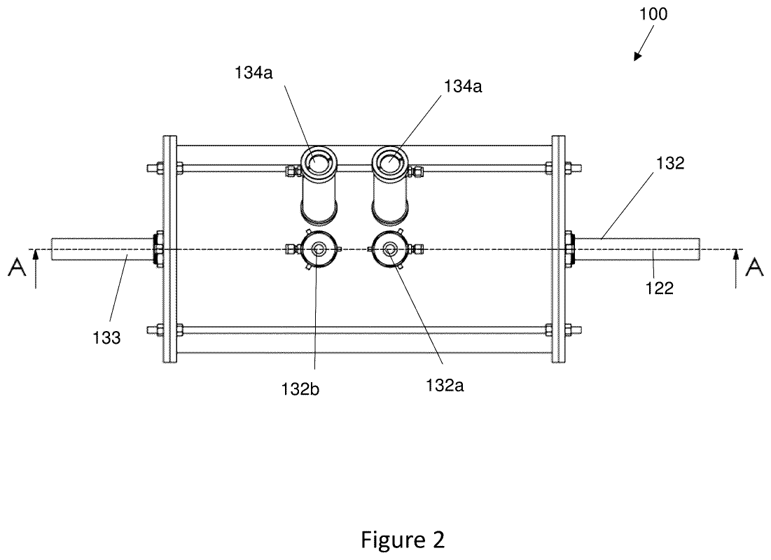

FIGS. 2, 3 and 4 shows different views of the apparatus 100 shown in FIG. 1. FIG. 2 shows the exterior of the housing 114 in accordance with an embodiment of the present invention. The housing 114 comprises a conduit passing through the housing 114 which comprises an input 132 and an output 133. The input 132 and output 133 of the conduit defines the longitudinal axis 122 of the apparatus. The input 132 is arranged to be in communication with a hydrocarbon fuel source (e.g. gas cylinder 200 not shown in FIG. 2) such that the input conduit 132 introduces the hydrocarbon fuel to the reaction chamber enclosed by the housing 114.

The housing further includes two housing units, 132a, 132b (e.g. housing pyrometers used to measure the temperature of the reaction chamber enclosed by the housing unit) and two corresponding viewing ports, 134a, 134b which may be used to align the pyrometers housed within the housing units 132a, 132b. As shown in FIG. 2, the two housing units 132a, 132b are longitudinally offset with respect to each other (e.g. the housing units are positioned at two positions along the longitudinal axis such that the pyrometers housed therein may measure the reaction chamber at two different positions).

The viewing ports, 134a, 134b, are provided at the same position along the longitudinal axis as the respective housing units 132a, 132b such that each housing unit 132a, 132b and viewing port 134a, 134b defines a plane perpendicular to the longitudinal axis. Each viewing port 134a, 134b and housing unit 132a, 132b are arranged to be angularly offset around the housing 114 such that the axis defined from the viewing port 134a, 1342b to the longitudinal axis 122 intersects the axis defined from the housing unit 132a, 132b to the longitudinal axis at the surface of the reaction chamber 102.

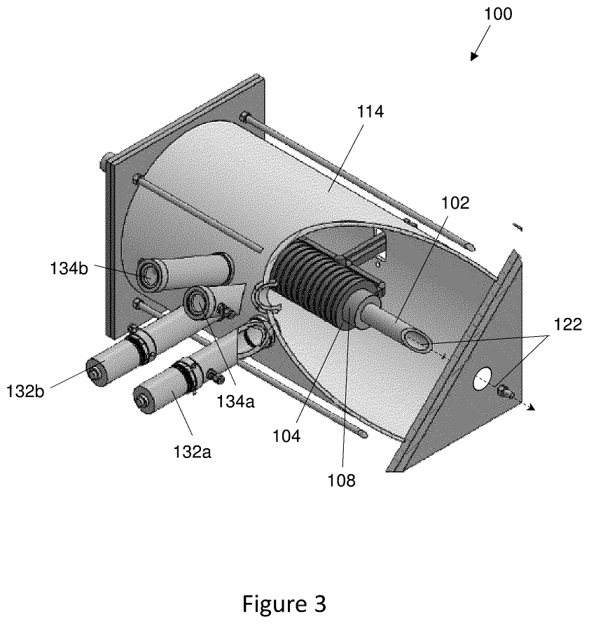

FIG. 3 shows a three-dimensional representation of the apparatus 100 shown in FIG. 2 with a cutaway portion showing the interior of the housing 114. The apparatus 100 shown comprises one reaction chamber 102 and a pair of electrically conducting coils 104 surrounding a part of the reaction chamber 102. The reaction chamber 102 is provided as a conduit (e.g. a pipe) that connects the housing input 132 and 133 and is thus centered on the longitudinal axis 122.

An insulating layer 108 is provided between the reaction chamber 102 and the electrically conducting coil 104. In the embodiment shown, the insulating layer 108 extends further along the reaction chamber 102 than the electrically conducting coil 104 (e.g. the insulating 108 layer is longer than the electrically conducting coil 104) to provide insulation against residual heating that occurs downstream of the region of the reaction chamber that is directly heated by the electrically conducting coil (e.g. the region of the reaction chamber that has part of the electrically conducting coil positioned perpendicularly to the reaction chamber) due to the heat radiating from the hydrocarbon fuel towards the wall(s) of the reaction chamber 102.

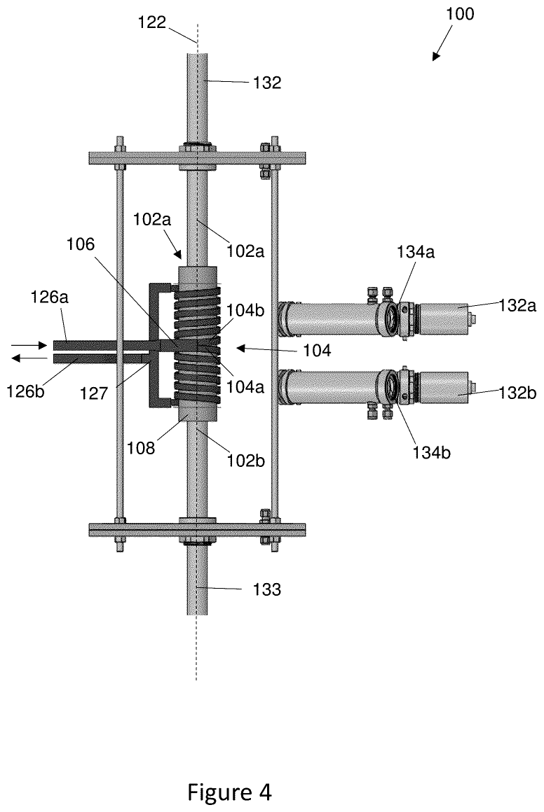

FIG. 4 shows a side-view of the apparatus housed within the housing shown in FIGS. 2 and 3. In the embodiment shown, a continuous conduit (e.g. a pipe) is provided through the reaction chamber and forms the housing input 132, the housing output 133 and the reaction chamber 102, including the reaction chamber input 102a and the reaction chamber output 102b. The reaction chamber 102 is surrounded by a pair of electrically conducting coils 104 both having a cylindrical shape (e.g. having a circular first cross-sectional shape and a plurality of turns having equal interior dimensions). The pair of electrically conducting coils 104 includes one electrically conducting coil having left handed turns 104a and one electrically conducting coil having right handed turns 104b. Both of the electrically conducting coils 104a, 104b branch from a common component 106 and turn outward from said branching point 106 such that the lengths of the electrically conducting coils extend in opposite directions parallel to the surface of the reaction chamber 102 and the longitudinal axis 122.

In the embodiment shown in FIG. 4, the pair of electrically conducting coils 104 are hollow to allow for water-cooling. Water is supplied to the coil through a common line 126a which is split at the branch point 106 at the center of the reaction chamber 102 before flowing outwardly from that center point (through each electrically conducting coil 104a, 104b in the pair of coils 104). The ends of the two electrically conducting coils 104a and 104b are then recombined at branch point 127 to provide a common output 126b for the water flowing through the electrically conducting coils 104.

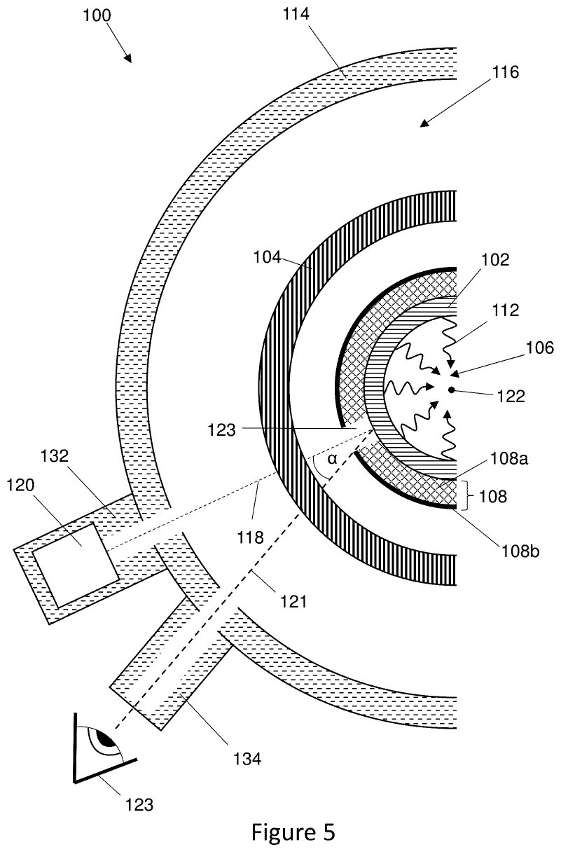

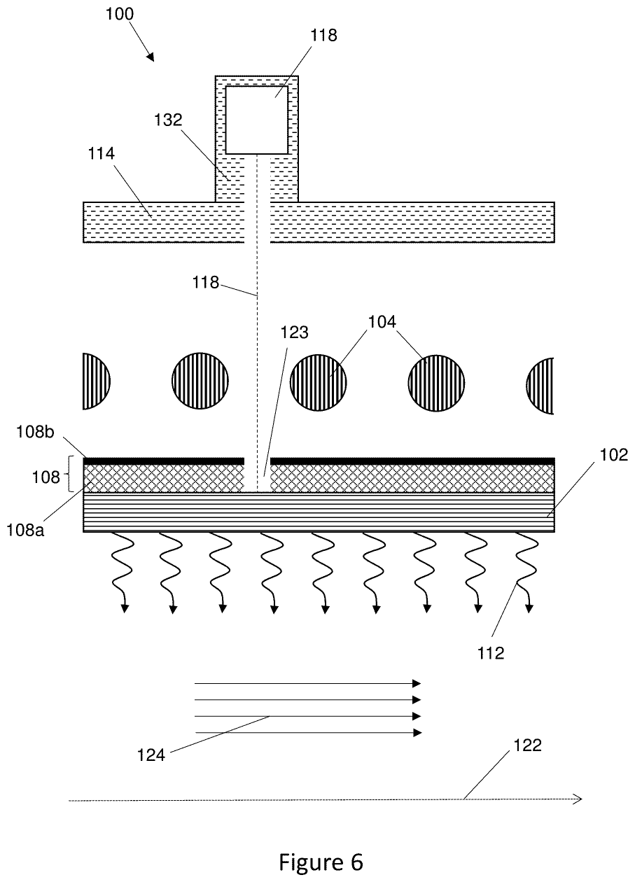

FIGS. 5 and 6 show cross-sectional views of the apparatus 100 shown in accordance with the embodiments shown in FIGS. 1 to 4 in the plane perpendicular to (FIG. 5) and parallel to (FIG. 6) the longitudinal axis 122.

FIG. 5 shows an embodiment of the apparatus 100 where the housing 114, insulating layer 108, the reaction chamber 102 and the electrically conducting coil's first cross-sectional shape are all circular and centered on the longitudinal axis 122. Similarly, FIG. 6 shows the electrically conducting coil having a circular second cross-sectional shape. However, it will be appreciated that FIGS. 5 and 6 represent exemplary embodiments only and the above described component cross-sections may be any suitable and desired shape with no requirement for all of the components to have the same or complementary cross-sectional shapes.

The apparatus 100 includes an electrically conducting coil 104 that is arranged to receive an alternating electric current such that an alternating magnetic field is generated. The alternating magnetic field penetrates the reaction chamber 102 such that the material of the reaction chamber 102 is heated (primarily at the reaction chamber surface 102 via the skin effect) by induction. The heat is conducted through the reaction chamber material and then radiated 112 into the cavity 106 (defined by the walls of the reaction chamber 102) comprising the hydrocarbon fuel 124 flowing therethrough.

The insulating layer 108 comprises a composite layer 108a with a layer of ultra-high ceramic ZrO₂ layer 108b at the surface, wherein the composite layer 108a comprises a plurality of ceramic fiber felt layers and a plurality of ZrO₂ layers disposed therebetween. The insulating layer 108 helps to prevent heat from radiating outward from the reaction chamber 102 and thus helps to improve the thermal efficiency of the apparatus 100.

The reaction chamber 102 in the embodiments shown in FIGS. 5 and 6 is made from tungsten metal and thus the insulating layer 108, in addition to improving the thermal efficiency, helps to minimize the oxidation of the tungsten metal to tungsten oxide. Preventing the oxidation of the tungsten reaction chamber 102 is further aided by providing a nitrogen environment 116 within the housing 114 such that the reaction chamber 102 is surrounded by an oxygen poor environment (thus reducing oxidation of the tungsten surface).

As with FIGS. 1 to 4, the housing 114 shown in FIGS. 5 and 6 comprises a housing unit 132 and a viewing port 134. (The viewing port 134 is not visible in FIG. 6 because it is positioned in the same plane perpendicular to the longitudinal axis 122 as the housing unit 132 and thus, in the embodiment shown, entirely obscured from view when the apparatus is viewed from the side-on.) The housing unit includes a pyrometer 120 which is arranged to output an infrared radiation beam 118 to contact the reaction chamber 102 by passing between two turns of the electrically conducting coil (see FIG. 6) and through a via 123 in the insulation layer 108. As such the pyrometer 120 may measure the temperature of the reaction chamber 102 at the point of contact.

As shown in FIG. 5, the viewing port 134 provides a line of sight 121 which intersects with the output radiation beam at the surface with an angle α such that a user 134 may use the viewing port 134 to align the output radiation beam 118 with the via 123 to optimize the quality of the temperature measurement.

For example, it may be envisaged that poor alignment of the output radiation beam 118 such that only a portion of the beam cross-section contacts the reaction chamber surface with the remaining portion contacting either the insulating layer 108 or the electrically conducting coil material may result in a temperature reading which corresponds to a weighted average of the temperature of all the surfaces contacted (e.g. the insulating layer 108 and/or the electrically conducting coil and the reaction chamber 102) and thus will not provide an accurate measurement of temperature of the reaction surface as is desirable.

Operation of the system 1000 and apparatus 100 will now be described with reference to FIGS. 1, 2, 3, 4, 5 and 6.

It may be preferred in some circumstances that a variety of operations are performed prior to the hydrocarbon fuel being flowed through the apparatus 100. For example, in order to optimize the efficiency of the pyrolytic decomposition, it is preferred to pre-heat the reaction chamber prior to introduction of the hydrocarbon fuel. Similarly, it may be preferable to modify the environment within the housing 114, such as supply gas (via a gas input supply line which connects to a supply source such as cylinder 200) or reduce the pressure (via a vacuum supply line) prior to heating the reaction chamber 102 to help minimize any undesirable side reactions (such as oxidation) of the reaction chamber 102 upon heating.

Water is also preferably input to the electrically conducting coils 104 in conjunction with the alternating electric current to allow temperature regulation of the electrically conducting coils 104 and minimize the effects of heat radiated from the reaction chamber 102 towards the electrically conducting coils 104 surrounding it.

As described above, the alternating electric current generator provides an alternating current input (via electrical connection with electrically conducting material 126) to the electrically conducting coil 104 surrounding the reaction chamber 102. The alternating current passing through the electrically conducting coil 104 generates an alternating magnetic field which penetrates the electrically conducting material of the reaction chamber to form eddy currents on the surface of the reaction chamber 102 which generates heat (primarily at the reaction chamber wall surface due to the skin effect). The heat is conducted through the wall of the reaction chamber 102 and radiated into the reaction chamber cavity to heat the hydrocarbon fuel flowing therethrough.

Hydrocarbon fuel enters the apparatus via a line which connects the hydrocarbon fuel supply (e.g. gas supply cylinder 200) to the reaction chamber 102 via the housing input 133. Upon flowing through the reaction chamber 102, the hydrocarbon fuel is heated and undergoes pyrolytic decomposition to provide carbonaceous solid products as well as gaseous products including hydrogen gas. To monitor the efficiency of the process, two pyrometers (housed in a housing unit 132a, 132b) allow the in-situ temperature measurement of the reaction chamber surface such that a control unit, upon receipt of the thermal reading, may output a control signal to the alternating current generator to vary the current input to the electrically conducting coil and thus change the temperature generated within the reaction chamber 102.

The products of the pyrolytic decomposition are output from the reaction chamber 102 and into the quenching chamber 300 (via housing output 133). The products flow through the quenching chamber 300 and undergo rapidly cooling (for example, by the addition of a coolant or polytropic or isentropic cooling) such that the products may be provided to downstream units such as the filter chamber 400.

Once passed into the filter chamber 400, the cooled solid carbonaceous products are separated from the cooled gaseous products. The solid products are collected whereas the gaseous products may pass directly into the mixing chamber 500 which is in fluid communication with the outlet of the filter chamber 400.

1. An apparatus for the pyrolytic decomposition of a hydrocarbon fuel into a plurality of products, the apparatus comprising:
a reaction chamber comprising:
an inlet for supplying hydrocarbon fuel into the reaction chamber; and
an outlet for the products of the pyrolytic decomposition; and
an electrically conducting coil surrounding the reaction chamber between the inlet and the outlet of the reaction chamber;
wherein the electrically conducting coil is arranged to receive an alternating current and heat the reaction chamber by induction.

2. The apparatus as claimed in claim 1, wherein the reaction chamber comprises at least one wall, wherein the electrically conducting coil is arranged to heat the at least one wall of the reaction chamber by induction.

3. The apparatus as claimed in claim 1, wherein the reaction chamber has no solid particulate material located therein.

4. The apparatus as claimed in claim 1, wherein the electrically conducting coil and the reaction chamber are not in direct contact.

5. The apparatus as claimed in claim 1, wherein the electrically conducting coil comprises a length such that the electrically conducting coil heats a portion of the reaction chamber of substantially the same length;
wherein the length ranges from 5 mm to 10 m.

6. The apparatus as claimed in claim 1, wherein the electrically conducting coil comprises a hollow cavity and the apparatus further comprises:
a fluid supply in connection with the electrically conducting coil for supplying fluid into the hollow cavity of the electrically conducting coil.

7. The apparatus as claimed in claim 1, wherein the electrically conducting coil comprises a plurality of turns ranging between 2 and 100 turns; and wherein the electrically conducting coil comprises a plurality of turns comprising a spacing between adjacent turns of the plurality of turns, wherein the spacing ranges from between 0.01 mm and 1 m.

8. (canceled)

9. The apparatus as claimed in claim 1, wherein the apparatus comprises one or more reaction chambers surrounded by two or more common electrically conducting coils.

10. The apparatus as claimed in claim 1, wherein the apparatus comprises a pair of electrically conducting coils;
wherein the pair of electrically conducting coils comprise a common line;
wherein the common line splits at a branch point to form the two electrically conducting coils in the pair of electrically conducting coils; and
wherein the common line is arranged to receive the alternating current.

11. (canceled)

12. (canceled)

13. The apparatus as claimed in claim 1, wherein the apparatus further comprises an insulating layer between the reaction chamber and the electrically conducting coil;
wherein the insulating layer is in direct contact with and surrounds the reaction chamber.

14. The apparatus as claimed in claim 1, wherein the insulating layer is in direct contact with and surrounds the reaction chamber;
wherein the insulating layer comprises an ultra-high temperature ceramic.

15. (canceled)

16. The apparatus as claimed in claim 13, wherein the insulating layer comprises at least one layer of an ultra-high temperature ceramic and at least one layer of ceramic fibre felt.

17. (canceled)

18. The apparatus as claimed in claim 1, wherein the apparatus further comprises a housing that encloses the reaction chamber and the electrically conducting coil; and
wherein the apparatus further comprises a gas supply line connected to the housing for supplying a flow of gas into the housing such that the gas surrounds the reaction chamber and displaces the gas within the housing.

19. (canceled)

20. The apparatus as claimed in claim 1, wherein the apparatus further comprises at least one thermal sensor arranged to measure the temperature of the reaction chamber at at least one position along the reaction chamber which is heated by the surrounding electrically conducting coil.

21. The apparatus as claimed in claim 20, wherein the apparatus further comprises an insulating layer between the reaction chamber and the electrically conducting coil;
wherein the insulating layer comprises at least one via; and
wherein the thermal sensor outputs a radiation beam that contacts the reaction chamber by passing through the at least one via.

22. The apparatus as claimed in claim 21, wherein the apparatus further comprises a control unit in communication with the thermal sensor, wherein the control unit is arranged to receive the temperature measurement from the thermal sensor.

23. A system comprising:
the apparatus as claimed in claim 1; and
a quenching chamber in fluid communication with, and downstream of the output of the reaction chamber and arranged to cool the plurality of products of the pyrolytic decomposition; and/or
a filter chamber for collecting and separating the products of the pyrolytic decomposition, wherein the filter is in fluid communication and downstream of the outlet of the apparatus.

24. A method for the pyrolytic decomposition of a hydrocarbon fuel into a plurality of products, the method comprising:
introducing a hydrocarbon fuel into a reaction chamber;
passing an alternating current through an electrically conducting coil surrounding the reaction chamber such that an alternating magnetic field is generated to inductively heat the reaction chamber; and
heating the hydrocarbon fuel in reaction chamber to effect pyrolytic decomposition of the hydrocarbon fuel.

25. The method as claimed in claim 24, the method further comprising:
receiving a temperature measurement of a position along the reaction chamber; and
comparing the temperature measurement to a pre-set desired temperature range, wherein the pre-set desired temperature range comprises an upper limit and a lower limit.

26. The method as claimed in claim 25, the method further comprising:
determining that the temperature of the position along the reaction chamber is above the upper limit or below the lower limit; and
transmitting a control signal to change the current of the alternating current passing through the electrically conducing coil if it is determined that the temperature is below the lower limit or above the upper limit.

27. (canceled)
